(19) United States
(12) Patent Application Publication
(10) Pub. No.: US 2017/0200147 A1
(43) Pub. Date: Jul. 13, 2017

(54) System and the computer methods of issuing, transferring and manipulating value or gift cards using blockchain technology

(71) Applicant: Akbar Ali Ansari, Hopkinton, MA (US)

(72) Inventor: Akbar Ali Ansari, Hopkinton, MA (US)

(21) Appl. No.: 15/401,010

(22) Filed: Jan. 7, 2017

Related U.S. Application Data
(60) Provisional application No. 62/276,475, filed on Jan. 8, 2016.

(51) Int. Cl. G06Q 20/34; G06Q 20/36; G06Q 20/38

(52) U.S. Cl. CPC G06Q 20/349; G06Q 20/382; G06Q 20/36

(57) ABSTRACT

The described invention consists of system and the computer methods of generating and manipulating value or gift cards which are cryptographically assigned to a person's identity and stored on double entry ledger called block chain. A functional module of the system allows the transfer of such value or gift cards to other persons. The functional module in the system further allows a person owning a card to split it into multiple value or gift cards, merge more than one value or gift cards to a single card, exchange a value or gift card with a specific merchant card, redeem a value or gift card at a store front in exchange for physical or digital good or cash it out in the currency it was issued. Each transaction associated with a customer is cryptographically signed and stored on the block chain.

### TECHNICAL FIELD

The current invention is related to the cryptographically secured smart value and gift card system which is capable of issuing and manipulating cryptographically secured value and gift cards using blockchain technology.

### BACKGROUND

The prior art of value or gift card industry has many drawbacks. The gift cards or value cards are not tied to a person's identity, hence vulnerable to the theft or misplacement. The gift cards are issued by proprietary systems and their values and activation is held in privacy by the issuer. Such systems are prime targets for hackers and fraudsters. Some of them come with expiration date and their value decay as function of time. A person usually ends up getting a card which can only be redeemed at particular store, which may not serve his needs. If a holder of a gift card wants to re-gift the same card to someone with a value which is different, he cannot split the value of the card. If a holder of gift cards wants to merge the value of more than one card into a single value, he may not be able to do it. The holder of a gift card may not be able to easily exchange or redeem it. He may have to go to secondary market at steep discounted price. It is also inconvenient to a gift giver as most of them come in fixed denominations.

It is this inflexibility and inconvenience of using gift card which results in most of them staying unused. According to one estimate some 23 Billion dollar worth of gift cards stayed unused in 2014 within USA.

The described innovation brings the efficiency to the gift card and value card industry and alleviates above mentioned drawbacks using blockchain technology.

### SUMMARY

Accordingly one embodiment of the current invention comprises of a system and computer methods to:
a) Accept a request from external systems like mobile application or web server.
b) Collect customer information including name, user name and password and store key artifacts in memory and on the disk.
c) Generate public key from the information collected from a customer, hash it and use the hashed value as the account id for the customer.
d) Accept a customer request for issuing a value or gift card for a certain value in a currency.
e) Process the payment for the requested value or gift card using external payment processor.
f) Generate a transaction of the said value, assign it to the public key of the customer and cryptographically sign it.
g) Write the unspent transaction on the distributed double entry ledger called blockchain.
h) Confirm the transaction on the blockchain.
i) Generate the image of the value or gift card and update the digital wallet of the customer.

In another embodiment, the value or gift card may be issued in any publicly acceptable currency and any denomination.

In another embodiment a value or gift card can be transferred and gifted to another identifiable person.

In another embodiment, the value or gift card when gifted may include suggestion to use it for purchasing a physical or digital good.

In another embedment a value or gift card may be split into more than one cards of equivalent value and each may be transferred independently.

In another embodiment, more than one value or gift cards can be merged into a single card of aggregated value.

In another embodiment a value or gift card may be redeemed for a specific merchant card available in the system.

In another embodiment a value or gift card may be directly used to purchase merchandise in a store front.

In another embodiment a value or gift card may be customized, printed and given to the recipient in physical form.

In another embodiment, a customer may track his value and gift cards purchase, transferred and received in a digital wallet.

### BRIEF DESCRIPTION OF THE DRAWINGS

FIG. 1 is a block diagram illustrating the AT Card System environment.

FIG. 2 is a block diagram illustrating the At Card System server and its modules.

FIG. 3 is a flow chart illustrating the customer registration in the At Card server environment.

FIG. 4 is a flow chart illustrating the purchase of value or gift card.

FIG. 5 is a flow chart illustrating the purchase of a value or gift card by a customer for another person

FIG. 6 is a flow chart illustrating the merging of 2 or more value or gift cards.

FIG. 7 is a flow chart illustrating the splitting of a value or gift card into multiple value or gift cards of multiple denominations.

FIG. 8 is a flow chart illustrating a customer owning a gift or value card to someone else.

FIG. 9 is a flow chart illustrating the redemption of a value or gift card against a merchant card.

FIG. 10 is a flow chart illustrating the redemption of a value or gift card with the currency it was issued in.

FIG. 11 is a flow chart illustrating the redemption of a value or gift card at a store front.

FIG. 12 illustrates the example digital or paper value or gift cards.

FIG. 13 illustrates the example merge and gifting of a value or gift cards.

FIG. 14 illustrates the example split and redemption of value or gift cards.

### DETAILED DESCRIPTION

The systems and methods of generating, transferring, redeeming and manipulating the value or gift cards using blockchain technology are described here in detail. The reference is made to the embodiments of the innovation described in the various illustrations and drawings.

A system consists of memory, processor and interfaced with network card and storage. The processor is capable of running special computer instructions to perform specific tasks described in the embodiment. The data captured from a customer is loaded in the memory and stored on the disk. The processor is further capable of communicating with external systems running specialized instructions like payment processors, banking interfaces and printers. The specialized computer instructions capable of running on processors may be grouped together called modules. The processor may also run specialized instructions or programs called database.

A blockchain is defined as sequential transaction database popularized by Bitcoin cryptocurrency and acts as distributed double entry ledger and records all the transactions ever performed by the system in time series sequential order. Each transaction on blockchain is part of an identifiable block which is written on the blockchain by the approved and authorized parties which are sometimes called miners or forgers.

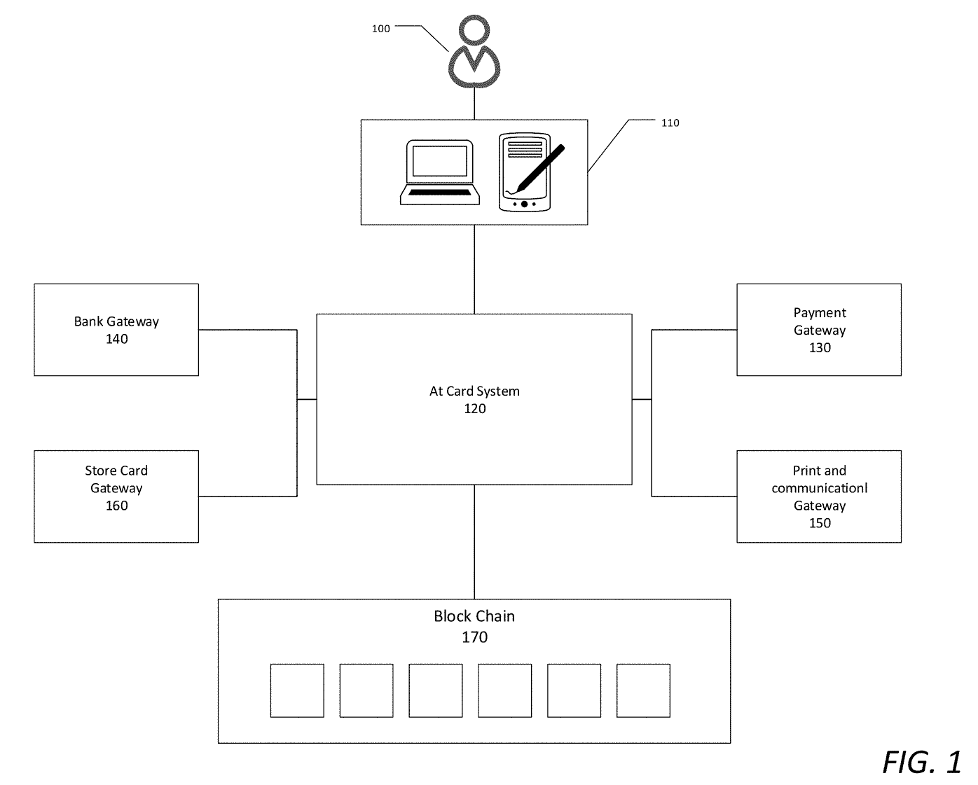

The FIG. 1 illustrates the AT Card system environment (120) receiving request from customer (100). The card system (120) is accessible but not limited to via Web browsers using HTTP/HTTPs protocol and mobile applications running on mobile operating systems like Android, IOS, and Windows or programmatically using standard APIs. The system accesses external services payment gateway (130), bank interface (140), printer (150), merchant gateway (160) and blockchain (170) over network running standard communication protocols.

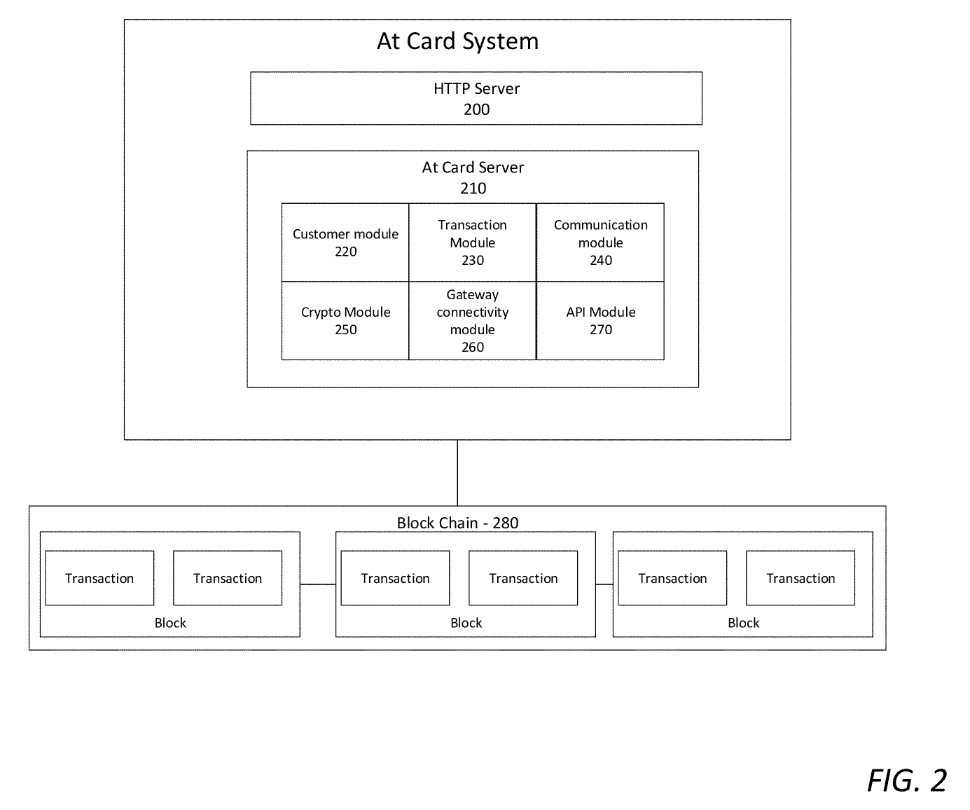

The FIG. 2 illustrates the AT Card system constituting an HTTP Server (200) which executes instructions to process incoming requests and forwards them to the At Card server (210) which consists of a collection of specialized computer instructions or programs called modules. The crypto module (250) is responsible for generating public and private key pairs. It is also responsible for running one way hash functions on public key to produce customer identifier. The customer module (220) provides function for registration and recording of customer on the disk. The transaction module (230) provides function of generating an unspent transaction when a value card is purchased, manipulated, transferred or redeemed and writing it on the blockchain (280). It also provides function of for splitting a value card or merging more than one value cards into one and transferring the value card or gift card to someone else. The communication module (240) provides the functionality to communicate with customers via email or SMS. The gateway connectivity module (260) provides functionality of connecting to external services via standard network protocols. The API module (270) provides standard runtime services for external programs to communicate with the card system programmatically.

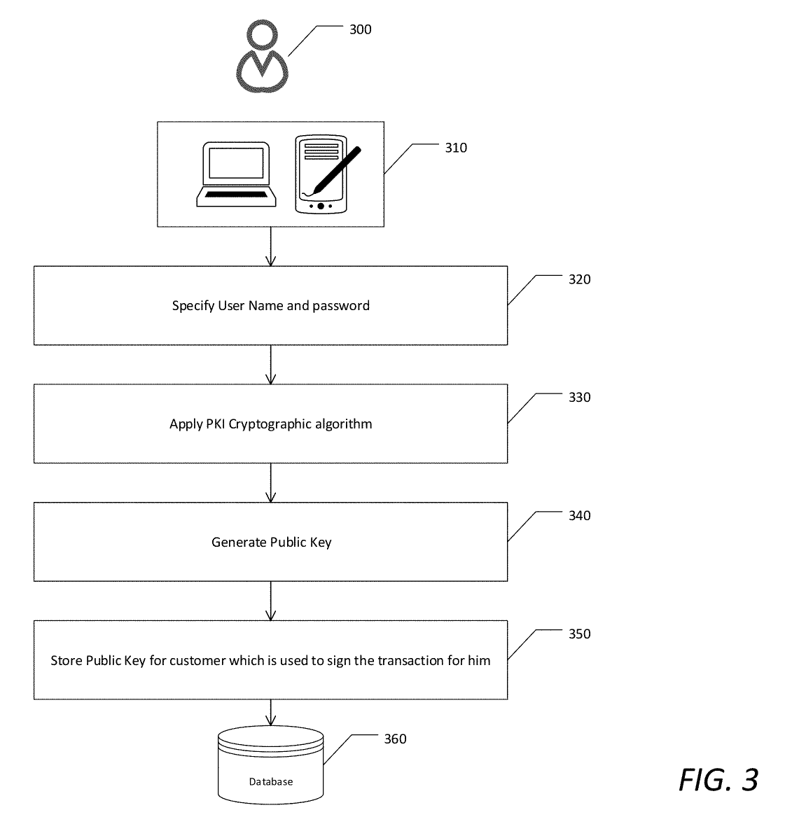

The FIG. 3 illustrates the flow chart of enrolling a customer in the system. Customer (300) accesses system using client interface (310). In step 320, system captures customer information including username and password, applies cryptographic methods in step 330 and generates public key in step 340 and stores all the captured and generated data in database in step 360. The system gathers user information using system memory during the registration process. In step 320, user provides username, password information along with other information. In step 330, system runs specialized computer instructions and cryptographic algorithms and produces public and private key pairs for the user in step 340. Another computer program is used to create one way hash of the public key which is used as the account identifier for the customer. In step 350, the generated and other collected data is stored in the database (360).

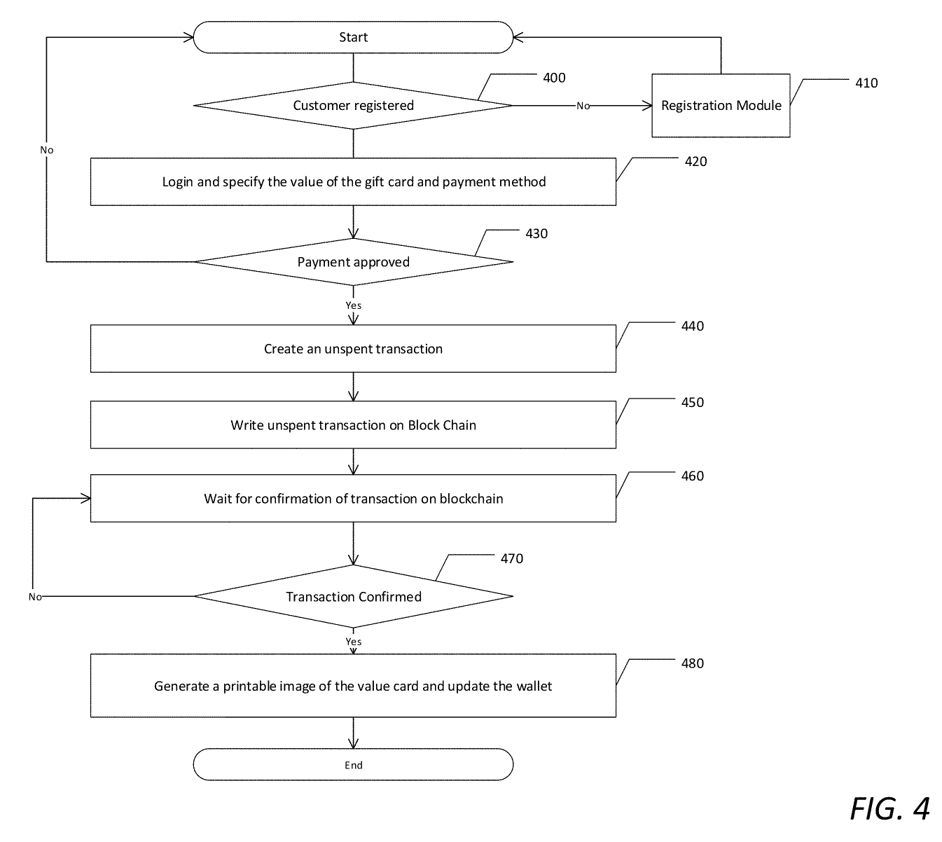

The FIG. 4 illustrates the flow chart of purchasing a value or gift card by a customer. In this embodiment a registered customer is presented the option to purchase a value or gift card in step 420. In this embodiment, a user logs into the system via a range of input devices and not limited to mobile and desktop devices using a wide range of protocols and not limited only HTTP/HTTPS. The user makes a selection to purchase the value card of certain value in certain currency. System offers a choice of payments to purchase the value card. Upon a user's selection of payment method in step 430, system reaches out to external systems and authorizes the payment. Once payment is authorized, system generated an unspent transaction signed by the customer's public key in step 440. The value of the card is cryptographically locked in the transaction which can only be unlocked by the customer's private key upon approval. The table 1 shows the details captured in the transaction data structure.

| Serial | |
|---|---|
| Number | Description of the attribute in Transaction |
| 1 | Public key of the owner, purchase or recipient |
| 2 | Amount of the value or gift card |
| 3 | Public key of the sender or the system |
| 4 | Block Id |
| 5 | Previous block Id |
| 6 | Markel root of the transaction |
| 7 | Transaction signature signed by sender or system key |

The unspent transaction is then written to the blockchain in step 450 and upon confirmation of the transaction in step 470, the sale of the value card or gift card is finalized in the name of the customer in step 480.

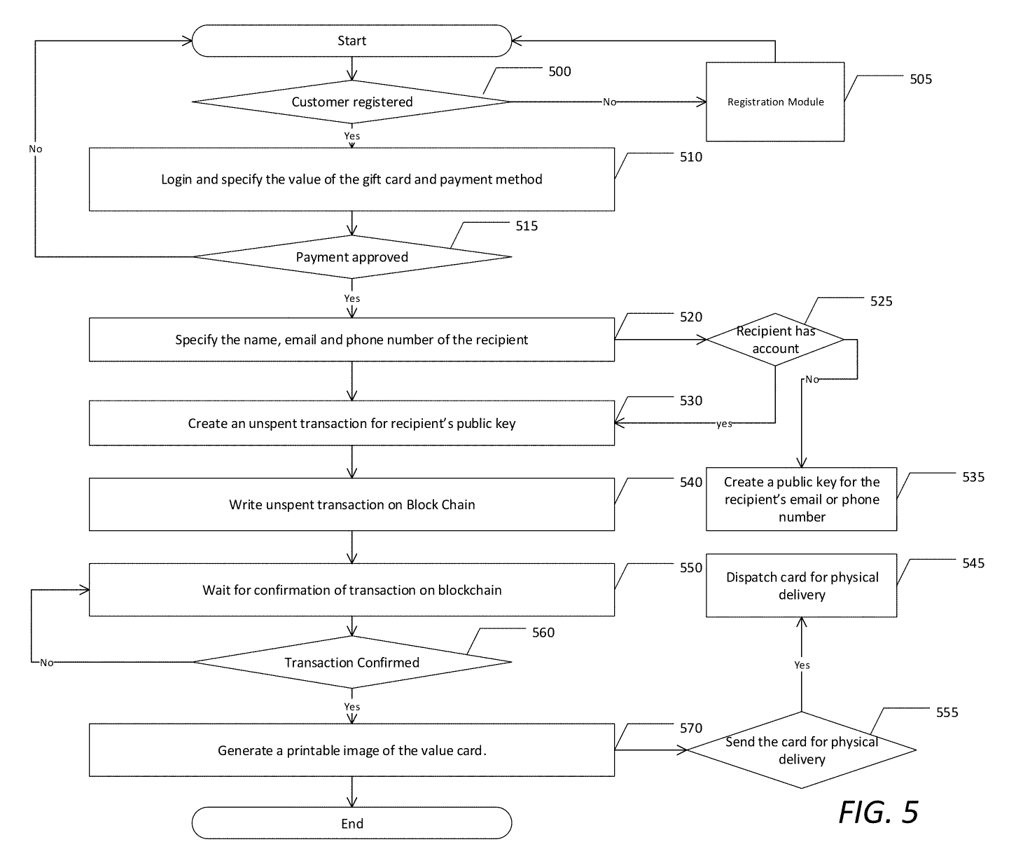

In another embodiment illustrated in flow chart in FIG. 5, a customer may directly purchase a value card or gift card for some other identifiable person. In this embodiment, in step 520, a customer specifies the name, address, email address and telephone number of the person a gift card is meant for. If the receiving person is already a customer, an unspent transaction is created and written to the blockchain in step 530 and 540 respectively. However, if the recipient is not a customer, system sends communication to the recipient via email and SMS that he has been gifted a value card by said person for specific value. In step 560, system will wait for the confirmation of the transaction on blockchain and upon confirmation will generate an image of the gift card in step 570 and initiate physical delivery in step 555.

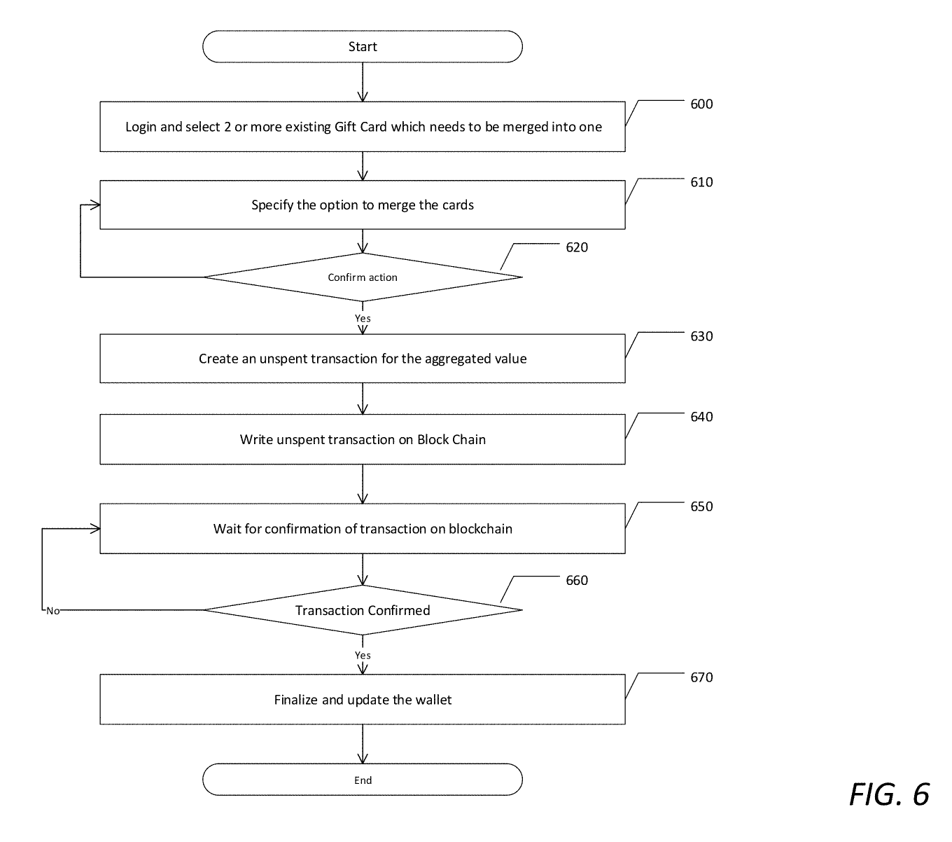

In another embodiment as illustrated in FIG. 6, a customer owning multiple value or gift cards may merge them into one single card of aggregated value. In step 600, a user logs into the system and chooses the cards to be merge into one card. Once his selection is finalized in step 610, system will ask to confirm the selection in step 620 and after confirmation generates a new unspent transaction in step 630 with aggregate value and will write it to the blockchain in step 640. The new unified value card is finalized upon the confirmation of the transaction in step 670 on the blockchain.

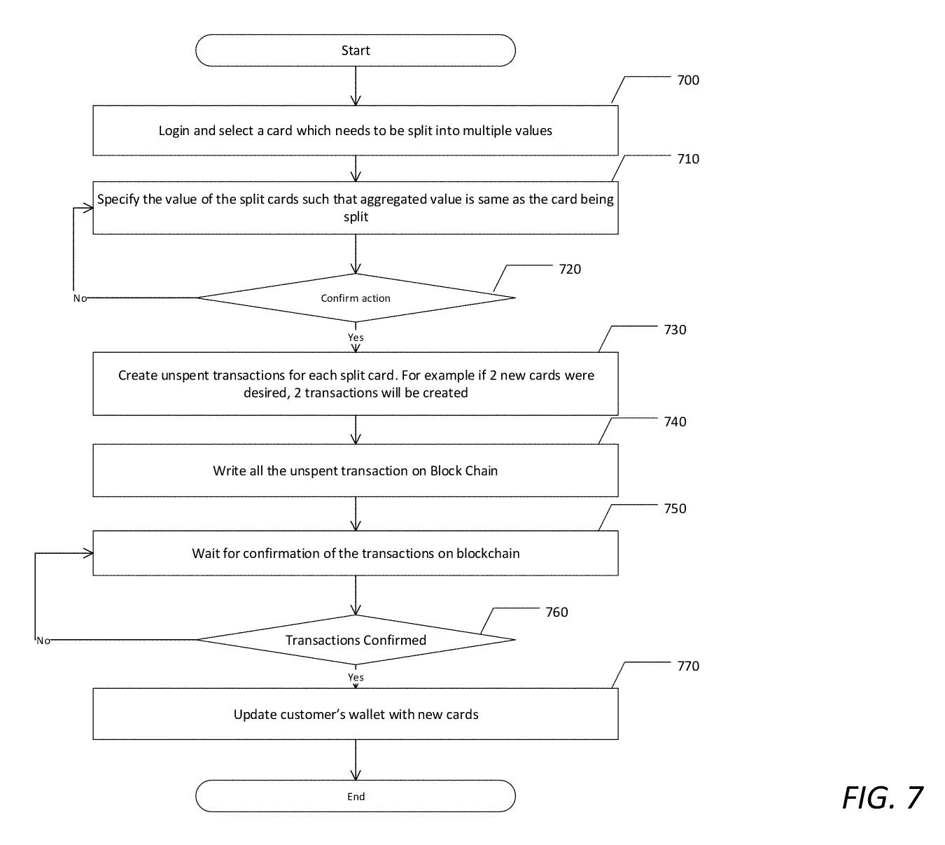

In another embodiment as illustrated in FIG. 7 a customer owning a gift card of certain value may choose to split it into multiple cards of different denominations. In step 700, a user logs into the system and selects an existing card of higher value to split. In step 710, user chooses the cards and their values to be split into. The system provides option to split into multiple cards of different denominations with sum total value of children card equaling the parent card. In step 720, user confirms his action and upon confirmation system generated multiple unspent transactions in step 730 and writes them on the blockchain in step 740. The systems waits for the confirmation of the transaction on the blockchain in step 750 and upon confirmation in step 760, he children cards get finalized and new cards are made available in the customer's wallet in step 770. Now each child card can be gifted or transferred independently.

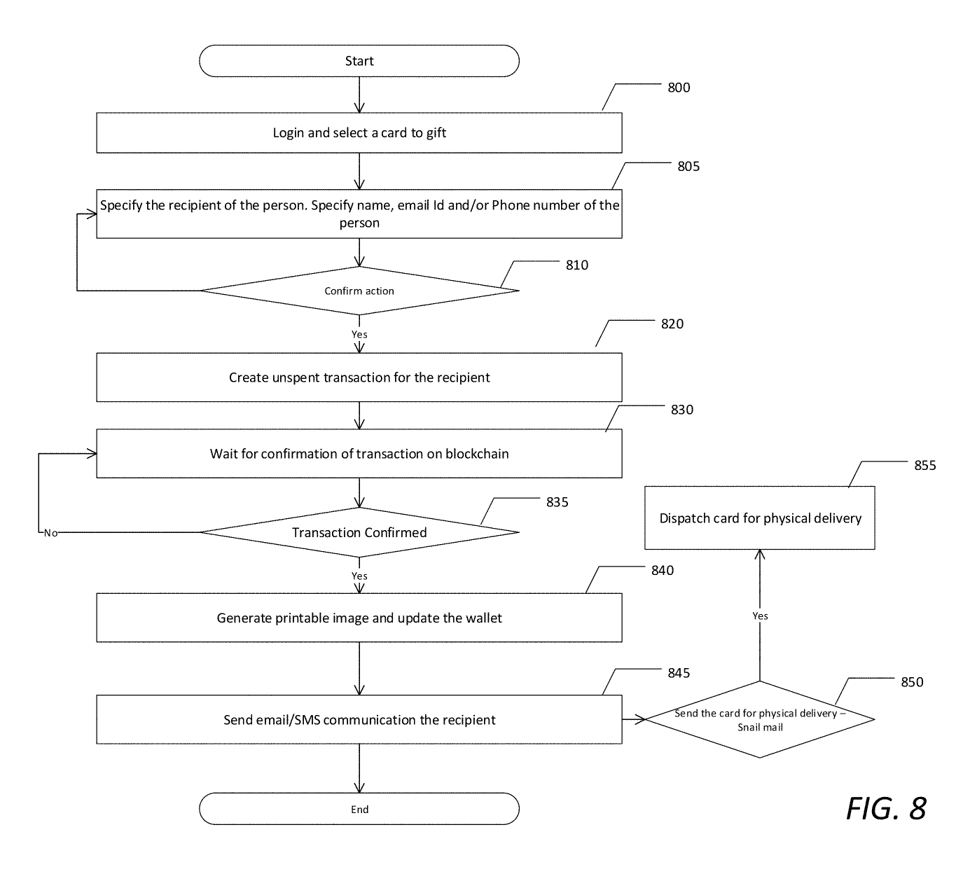

In another embodiment as illustrated by flow chart in FIG. 8, a customer owning a value or gift card may like to gift it to someone else by customizing it and transferring the ownership. In this embodiment, in step 800 customer logs into the system and selects the card which he wants to transfer. In step 805, he specifies the name, email address, phone number and address of the person he intends to gift the card. He may also suggest the purpose of gifting. The purpose may suggest redeeming the card towards purchase of a certain physical or digital good at a certain merchant. Upon approving the intention of transfer by the customer in step 810, system generates an unspent transaction in step 820 and writes on blockchain in step 830. In step 835, system waits for the transaction to be confirmed on blockchain and after confirmation generates the image of new card and updates the wallet in step 840. In step 845 System notifies the recipient of the card by email/SMS about the new gift card and if physically delivery of the card is desired, system initiates the process of physical delivery in step 850. In another embodiment, a customer owning a value card may decide to exchange it for a merchant card. In this embodiment, a customer chooses the option of redeeming a value card with a merchant card available in the system. Upon approval of his intent to redeem, system communicates with external merchant card system and purchases a merchant card and places it in the customer's wallet. It then creates a transaction marking the redemption of the value card.

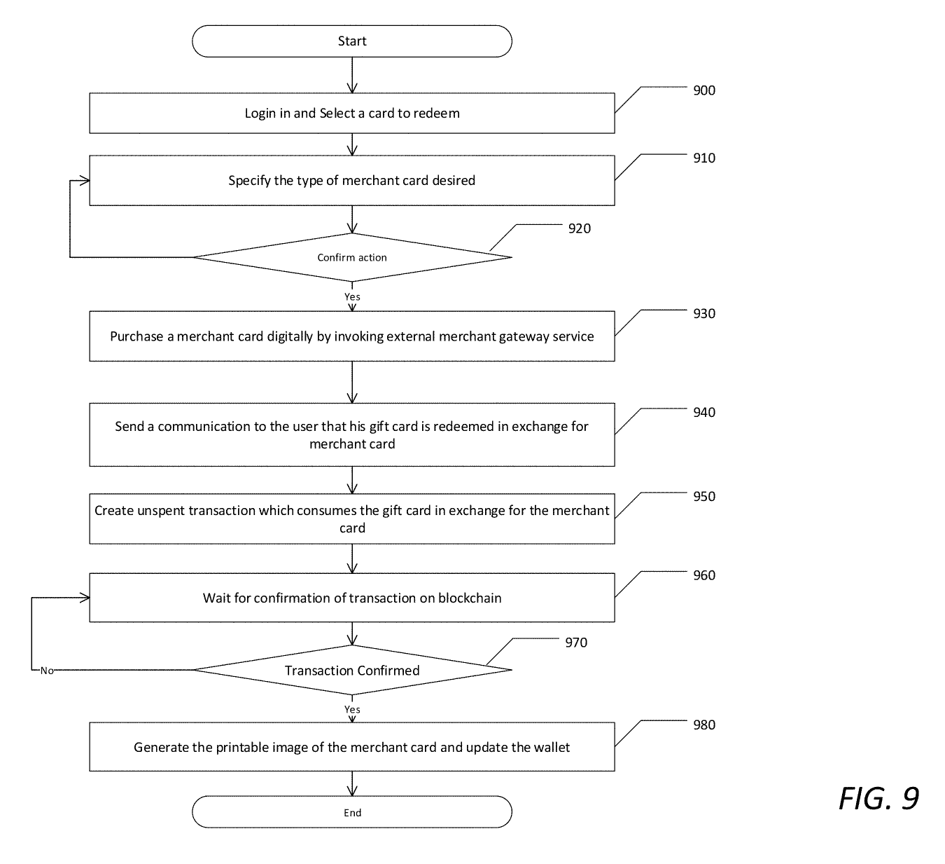

In another embodiment as illustrated in flow chart in FIG. 9, a customer owning a value or gift card may decide to redeem it for a store merchant card. In this embodiment, a customer logs into the system and chose a card to redeem in step 900. In step 910, customer chose a merchant card he would like to redeem with and confirm his action in step 920. In step 930, system communicates with merchant gateway and purchases a merchant store card. In step 940, system notifies the customer that a store card has been redeemed for his value card. In step 950, system creates an unspent transaction and writes it on the blockchain in step 960. In step 970, system waits for the transactions to be confirmed on the blockchain and upon confirmation generates a printable image of the store merchant card in step 980 and updates the wallet.

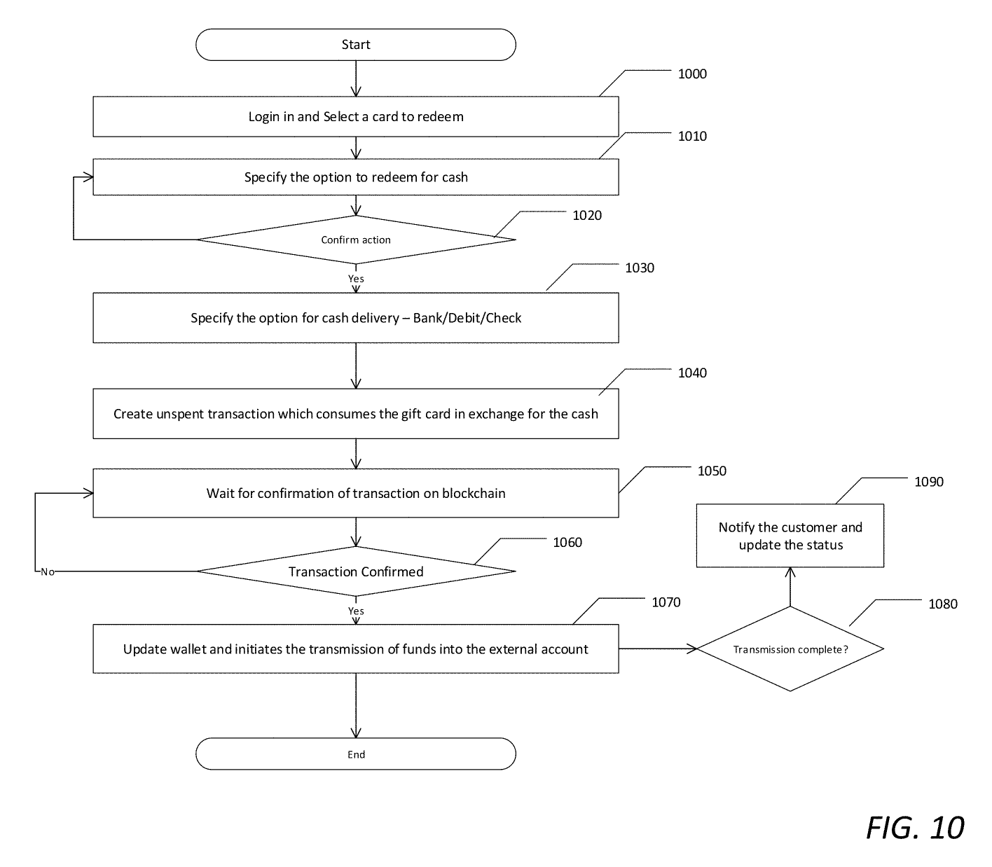

In another embodiment as illustrated in flow chart in FIG. 10, a customer owning a value card may decide to redeem it for the currency it was issued in. In this embodiment, in step 1000, a customer logs in and chose to redeem the value or gift card. In step 1010 he chose the option to redeem with currency. In step 1020 he confirms the selection and in step 1030, he specified the external recipient accounts. In step 1040, system creates an unspent transaction and writes on blockchain in step 1050. After confirmation of the transaction on blockchain in step 1060, system updates the wallet and initiates the transmission of the funds in step 1070. In step 1080 confirms the delivery of the funds and updates the status in step 1090.

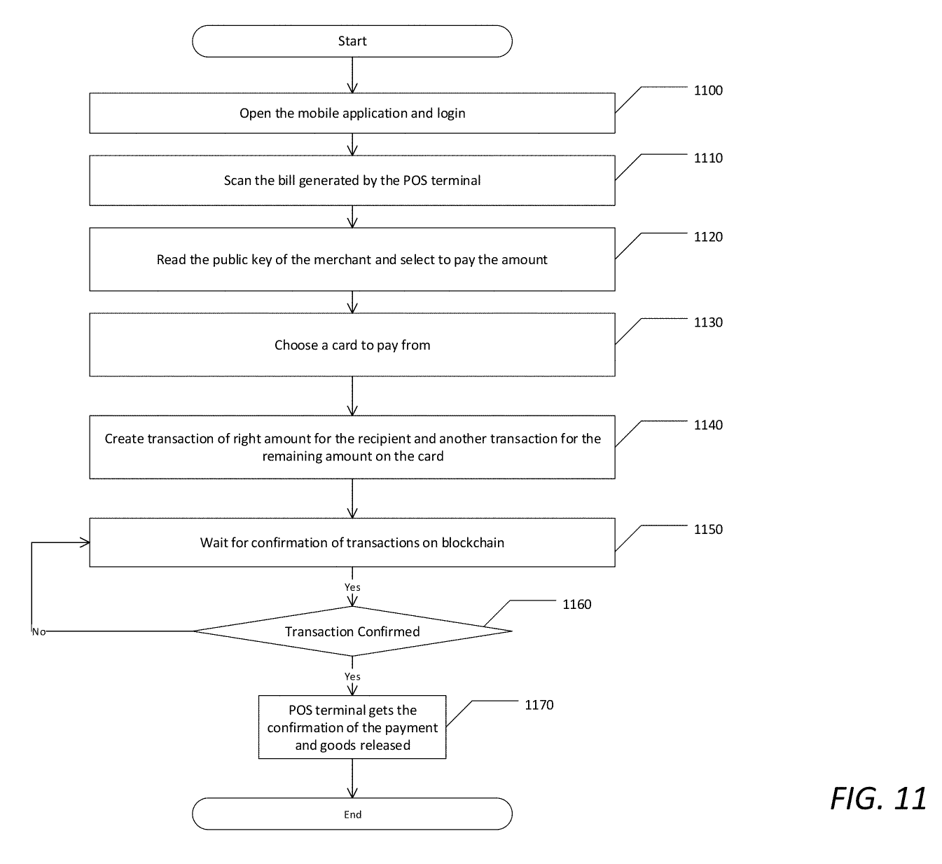

In yet another embodiment as illustrated in FIG. 11, a customer owning a value or gift card may decide to redeem it at participating store front in exchange for goods. In this embodiment, the customer chose to transfer ownership of the value card to the store front in exchange for goods. Upon, approval, system, the value card is transferred to the public key of the store front and an unspent transaction gets written to the blockchain to finalize the transfer. In step 1100, customer logs into the mobile application. In step 1110, bill produced by the merchant is scanned by the mobile application and the public key of the store is read in step 1120. In step 1130, customer chose a card to pay the bill from. In step 1140, system creates the transactions for the payment and writes them on the blockchain. In step 1160, system waits for the transaction to be confirmed on the blockchain. Upon confirmation of the transaction in step 1170, the store front is notified in step 1180 and goods are released for the customer.

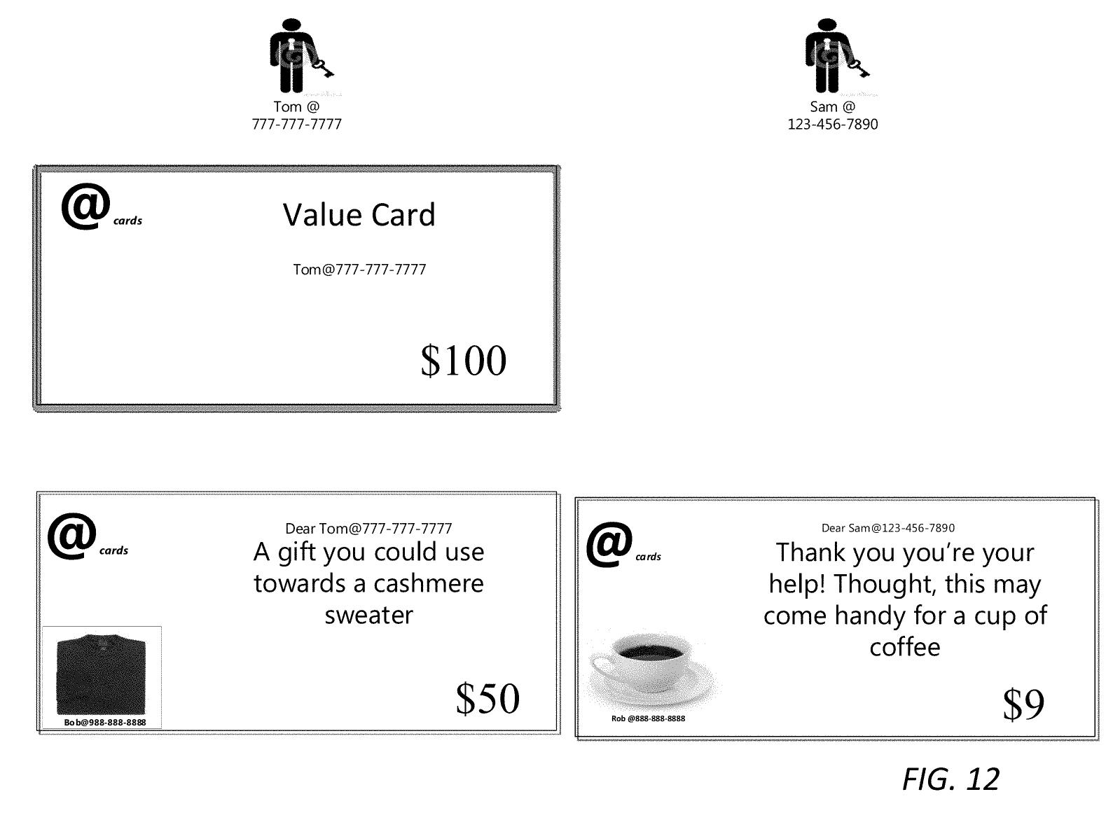

The FIG. 12 provides screen shots of example value and gift cards. In these examples Tom buys a Value card for $100 and receives a gift card in the amount of @50 from Bob. Another person Sam receives a gift card toward a cup of copy for $9.

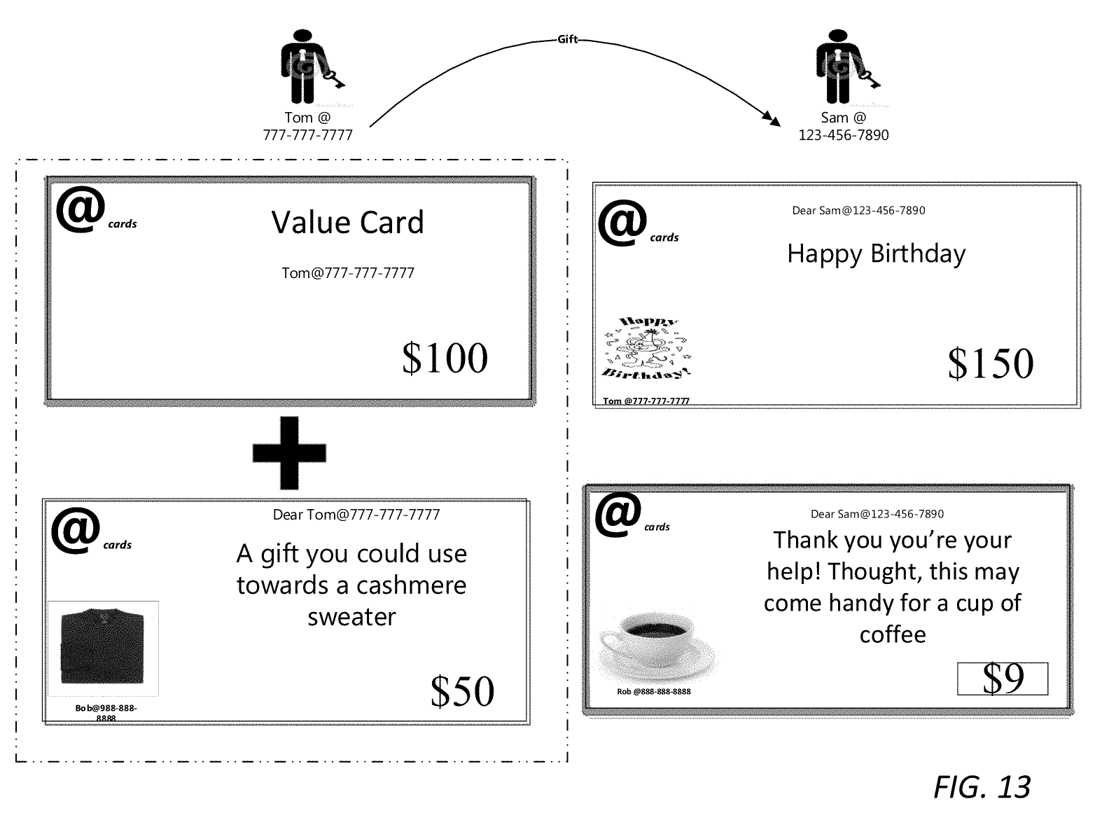

The FIG. 13 demonstrates sample transactions between Tom and Sam. Tom merges the value of cards for $100 and $50 demonstrated in FIG. 12 and creates a merged gift card of $150 and sends this to Sam.

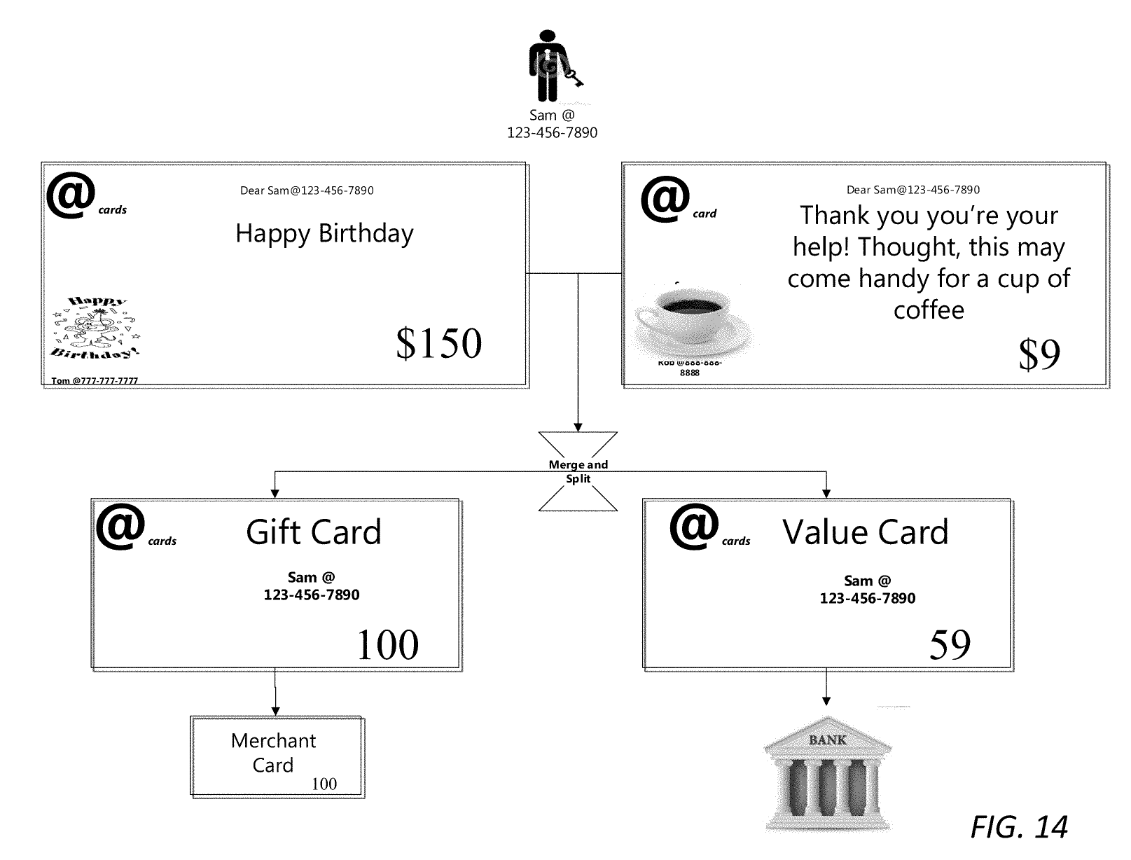

The FIG. 14 demonstrates the sample transactions where Sam merges his gift cards and splits into different values and redeems them. Sam merges the 2 cards he has in his wallet as demonstrated in FIG. 13—$150 and $9 and split them into $100 gift card and $50 value cards. He redeems $100 gift card for a store merchant card and $59 value card for currency in his bank.

1. A system comprising:
a. A memory which is coupled with microprocessor and is capable of storing customer and transaction information.
b. HTTP Server operating on or more microprocessors and is capable of accepting plurality of requests from external clients over the network. The HTTP Server executes computer instructions upon receiving the requests and forward to the At Card Server.
c. At Card Server operating on one or more microprocessors and run plurality of components. It executes computer instructions and results the system to:
i. Receive request from HTTP server and collect new user information and upon validation create an account in the system
ii. Generate public and private keys using specialized cryptographic algorithms based upon username and password information supplied by the user and store public key in the system along with other customer information
iii. Receive request to purchase a value or gift card of a certain value and process request and call external payment gateway to process the payment over TCP/IP network using appropriate communication protocols
iv. Generate an unspent transaction for the value card request and store it on the block chain. The unspent transaction digitally signs the transaction giving the owner of the public key the right to redeem, transfer and use the value associated with the card.
v. Generate a gift or value card for the customer and update the digital wallet
d. Block Chain popularized by cryptocurrencies, operating on one more microprocessors and executes computer instructions which upon execution accepts transactions and stores them in the order of sequence in blocks. A group of transactions form a block and sequence of blocks form block chain.

2. The system of claim 1 where system is extended to execute instructions where a customer owning a value or gift card may transfer it to some other person. The new transaction of the transfer of ownership gets recorded on the block chain.

3. The system of the claim 1 where systems is extended to execute instructions where a customer owning a value or gift card may split it into more than one value cards with sum of the values equaling the parent card value.

4. The system of the claim 3 where systems is extended to execute instructions where a customer owning a value or gift card may split it into more than one value cards with sum of the values equaling the parent card value in a different currency.

5. The system of claim 1 where system is extended to execute instructions where a customer owning more than one value or gift card may merge them into one single aggregated value card.

6. The system of claim 5 where system is extended to execute instructions where a customer owning more than one value or gift card may merge them into one single aggregated value card and issued in different currency.

7. The system of claim 1 where systems is extended to execute instructions where a customer may purchase a value or gift card for some other identifiable person.

8. The system of claim 2 where system is extended to execute instructions where a customer may send the value or gift card to a recipient for some intended purpose

9. The system of claim 2 where system is extended to execute instructions where a customer may send the gift card to a recipient for acquiring a physical or digital good

10. The system of claim 2 where systems is extended to execute instructions where system sends notification to the recipient of the gift card by email or SMS informing about his ownership of the new gift card

11. The system of claim 1 where system is extended to execute instructions where owner of a value card may redeem it for a merchant card.

12. The system of claim 11 where system is extended to execute instructions where it connects with external merchant systems and makes purchase of the merchant store cards.

13. The system of claim 11 where system is extended to execute instructions where a customer is communicated when a value or gift card is redeemed against a merchant store card.

14. The system of claim 1 where system is extended to execute instructions where owner of a value card may redeem it for currency it was purchased in.

15. The system of claim 14 where system is extended to execute instructions where system connect to external financial systems to initiate deposit of the redeemed value

16. The system of claim 1 where system is extended to execute instructions where owner of a value card may redeem it at the store front in exchange for physical or digital goods

17. The system of claim 1 where system is extended to execute instructions where blockchain used may be public blockchain from bitcoin system.

18. The system of claim 17 where system is extended to execute instructions where concept of color coin used to write transactions on public blockchain using open asset protocol.

19. The system of claim 1 where system is extended to execute instructions where blockchain may be shared with other participants in the system who may be given the right to write transactions and create blocks

20. The system of claim 19 where system is extended to execute instructions where proof of work, proof of stake or any other algorithms are used to create block on block chain by the system participants.
